(19) United States
(12) Patent Application Publication
(10) Pub. No.: US 2012/0070684 A1
(43) Pub. Date: Mar. 22, 2012

(54) THERMAL CONDUCTIVITY SUBSTRATE AND MANUFACTURING METHOD THEREOF

(75) Inventors: Chin-Sheng Wang, Hsinchu County (TW); Ching-Sheng Chen, Hsinchu County (TW); Chien-Hung Wu, Hsinchu County (TW)

(73) Assignee: SUBTRON TECHNOLOGY CO. LTD., Hsinchu County (TW)

(21) Appl. No.: 13/046,785

(22) Filed: Mar. 14, 2011

(30) Foreign Application Priority Data
Sep. 17, 2010 (TW) 99131636

(51) Int. Cl. B32B 15/04; B32B 38/00; C25D 5/16; B32B 37/00

(52) U.S. Cl. 428/621; 156/182; 205/95

(57) ABSTRACT

A thermal conductivity substrate including a metal substrate, a metal layer, an insulating layer, a plurality of conductive structures, a first conductive layer and a second conductive layer is provided. The metal layer is disposed on the metal substrate and entirely covers the metal substrate. The insulating layer is disposed on the metal layer. The conductive structures are embedded in the insulating layer and connected to a portion of the metal layer. The first conductive layer is disposed on the insulating layer. The second conductive layer is disposed on the first conductive layer and the conductive structures. The second conductive layer is electrically connected to a portion of the metal layer through the conductive structures. The second conductive layer and the conductive structures are integrally formed.

### CROSS-REFERENCE TO RELATED APPLICATION

This application claims the priority benefit of Taiwan application serial no. 99131636, filed on Sep. 17, 2010. The entirety of the above-mentioned patent application is hereby incorporated by reference herein and made a part of this specification.

### BACKGROUND

1. Field of the Invention

The invention relates to a substrate and a manufacturing method thereof. Particularly, the invention relates to a thermal conductivity substrate of a high thermal conductivity demand and a manufacturing method thereof.

2. Description of Related Art

Purposes of chip packaging are to provide a suitable signal path, a heat conduction path and a structure protection for a chip. A conventional wire bonding technique generally uses a leadframe to serve as a carrier of the chip. As a contact density of the chip is gradually increased, the leadframe cannot provide higher contact density, so that a package substrate having a high contact density is used to replace the leadframe, and the chip is packaged to the package substrate through conductive media such as metal wires or bumps, etc.

The package substrate is mainly formed by a metal substrate, multiple patterned conductive layers on the metal substrate and at least one insulating layer, wherein the insulating layer is disposed between two adjacent patterned conductive layers. Generally, an adhesion layer is disposed between the chip and the package substrate. The chip is fixed on the package substrate through the adhesion layer and is electrically connected to the package substrate, and heat generated by the chip can be conducted to the metal substrate through the adhesion layer, the patterned conductive layers and the insulating layer. However, since thermal conductivities of the adhesion layer and the insulating layer are relatively poor, when the heat generated by the chip is conducted to the metal substrate through the adhesion layer and the insulating layer, a thermal resistance is increased, which may cause poor heat conduction. Therefore, how to efficiently conduct the heat generated by the chip to external is an important issue for those related designers.

### SUMMARY OF THE INVENTION

The invention is directed to a thermal conductivity substrate, which has a better thermal conductivity effect.

The invention is directed to a method for manufacturing a thermal conductivity substrate, which is used for manufacturing the aforementioned thermal conductivity substrate.

The invention provides a thermal conductivity substrate including a metal substrate, a metal layer, an insulating layer, a plurality of conductive structures, a first conductive layer and a second conductive layer. The metal layer is disposed on the metal substrate and entirely covers the metal substrate. The insulating layer is disposed on the metal layer. The conductive structures are embedded in the insulating layer and are connected to a portion of the metal layer. The first conductive layer is disposed on the insulating layer. The second conductive layer is disposed on the first conductive layer and the conductive structures. The second conductive layer is connected to a portion of the metal layer through the conductive structures. The second conductive layer and the conductive structures are integrally formed.

In an embodiment of the invention, the thermal conductivity substrate further includes a medium layer, which is disposed between the metal substrate and the metal layer.

In an embodiment of the invention, a material of the medium layer includes zinc or copper.

In an embodiment of the invention, the first conductive layer exposes a portion of the insulating layer.

The invention provides a method for manufacturing a thermal conductivity substrate, which includes following steps. A metal substrate is provided. A metal layer is formed on the metal substrate, wherein the metal layer entirely covers the metal substrate. A laminated structure is compressed on the metal layer. The laminated structure includes an insulating layer and a first conductive layer, wherein the insulating layer has a plurality of openings, and the openings expose a portion of the metal layer. A second conductive material layer is formed on the first conductive layer and inner walls of the openings, wherein the second conductive material layer fills the openings to form a plurality of conductive structures, and the second conductive material layer located on the first conductive layer is connected to a portion of the metal layer through the conductive structures.

In an embodiment of the invention, before the metal layer is formed on the metal substrate, a surface treatment is first performed to the metal substrate.

In an embodiment of the invention, the step of performing the surface treatment includes forming a medium layer on the metal substrate.

In an embodiment of the invention, a material of the medium layer includes zinc or copper.

In an embodiment of the invention, a method of forming the second conductive material layer on the first conductive layer and the inner walls of the openings includes electroplating.

In an embodiment of the invention, after the second conductive material layer is formed, the second conductive material layer is further patterned to form a second conductive layer on the first conductive layer.

According to the above descriptions, in the thermal conductivity substrate of the invention, the metal layer entirely covers the metal substrate, and the conductive layer is connected to the metal layer through the conductive structures. Therefore, when a heat-generating element is disposed on the thermal conductivity substrate, heat generated by the heat-generating element can be quickly conducted to external through the conductive layer, the conductive structures, the metal layer and the metal substrate. In this way, the thermal conductivity substrate of the invention can effectively dissipate the heat generated by the heat-generating element, so as to improve a utilization efficiency and a utilization lifespan of the heat-generating element.

In order to make the aforementioned and other features and advantages of the invention comprehensible, several exemplary embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a cross-sectional view of a thermal conductivity substrate according to an embodiment of the invention.

FIGS. 2A-2G are cross-sectional views of a manufacturing method of a thermal conductivity substrate according to an embodiment of the invention.

### DETAILED DESCRIPTION OF DISCLOSED EMBODIMENTS

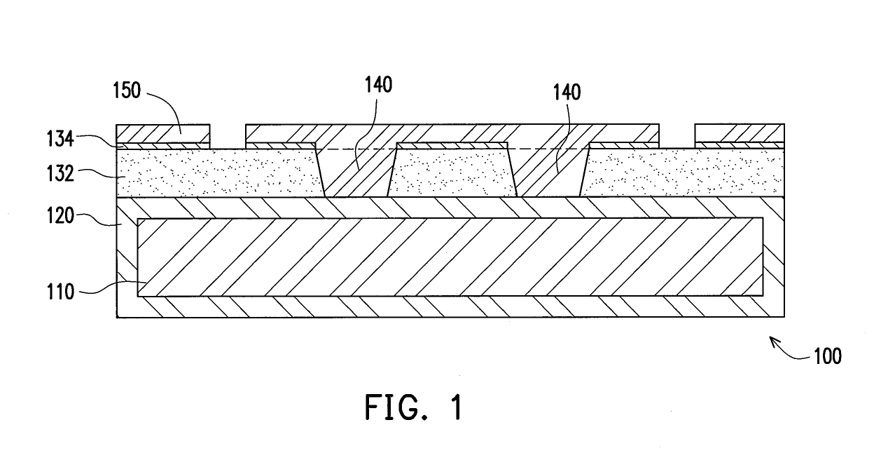

FIG. 1 is a cross-sectional view of a thermal conductivity substrate according to an embodiment of the invention. Referring to FIG. 1, in the present embodiment, the thermal conductivity substrate 100 includes a metal substrate 110, a metal layer 120, an insulating layer 132, a plurality of conductive structures 140, a first conductive layer 134 and a second conductive layer 150.

In detail, the metal substrate 110 of the present embodiment is, for example, a copper substrate, a copper alloy substrate, an aluminium substrate or an aluminium alloy substrate with a good thermal conductivity, though the invention is not limited thereto. The metal substrate 110 can quickly conduct heat generated by a heat-generating element (not shown), so as to reduce a working temperature of the heat-generating element. In the present embodiment, the metal substrate 110 is, for example, the aluminium substrate. The metal layer 120 is disposed on the metal substrate 110 and entirely covers the metal substrate 110, wherein a material of the metal layer 120 is, for example, copper. The insulating layer 132 is disposed on the metal layer 120. The conductive structures 140 are embedded in the insulating layer 132, and are connected to a portion of the metal layer 120. The first conductive layer 134 is disposed on the insulating layer 132, wherein the first conductive layer 134 exposes a portion of the insulating layer 132. The second conductive layer 150 is disposed on the first conductive layer 134 and the conductive structures 140, wherein the second conductive layer 150 is connected to a portion of the metal layer 120 through the conductive structures 140, and the second conductive layer 150 and the conductive structures 140 are, for example, integrally formed.

In the thermal conductivity substrate 100 of the present embodiment, since the metal layer 120 entirely covers the metal substrate 110, and the second conductive layer 150 is connected to the metal layer 120 through the conductive structures 140, when the heat-generating element (not shown) is disposed on the thermal conductivity substrate 100, heat generated by the heat-generating element can be quickly conducted to external sequentially through the second conductive layer 150, the conductive structures 140, the metal layer 120 and the metal substrate 110. In this way, the thermal conductivity substrate 100 of the present embodiment can effectively dissipate the heat generated by the heat-generating element, so as to improve a utilization efficiency and a utilization lifespan of the heat-generating element. Moreover, since the aluminium substrate is used as the metal substrate 110, a whole weight of the thermal conductivity substrate 100 can be lighter compared to that of a copper substrate having the same size, and a cost thereof is relatively low.

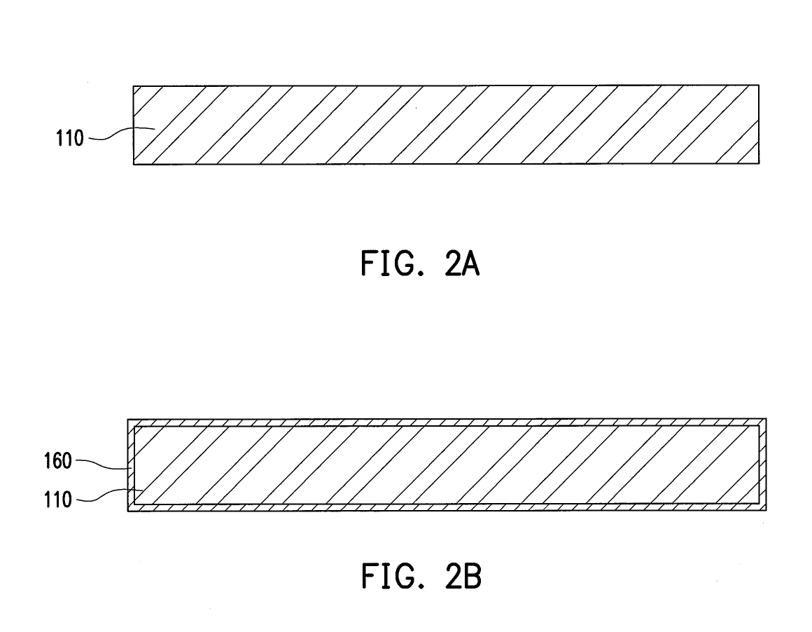

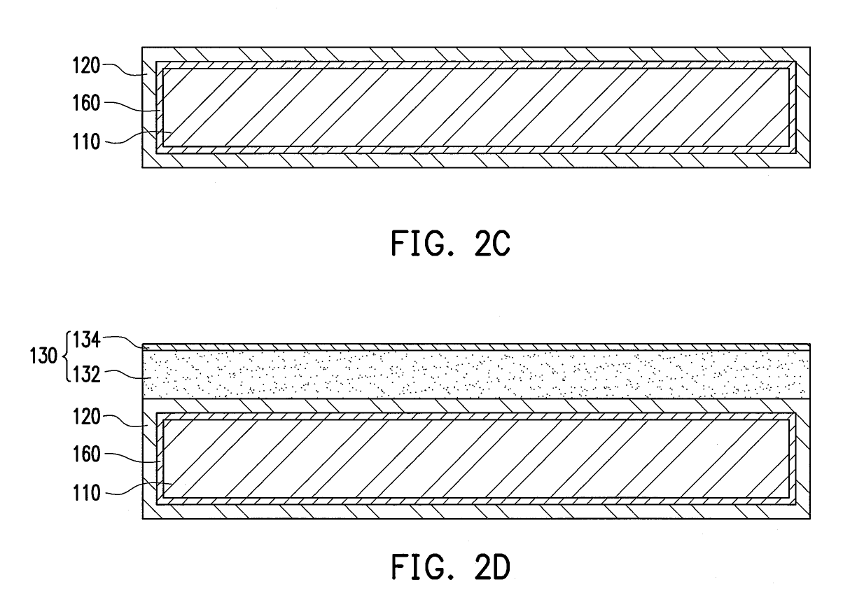

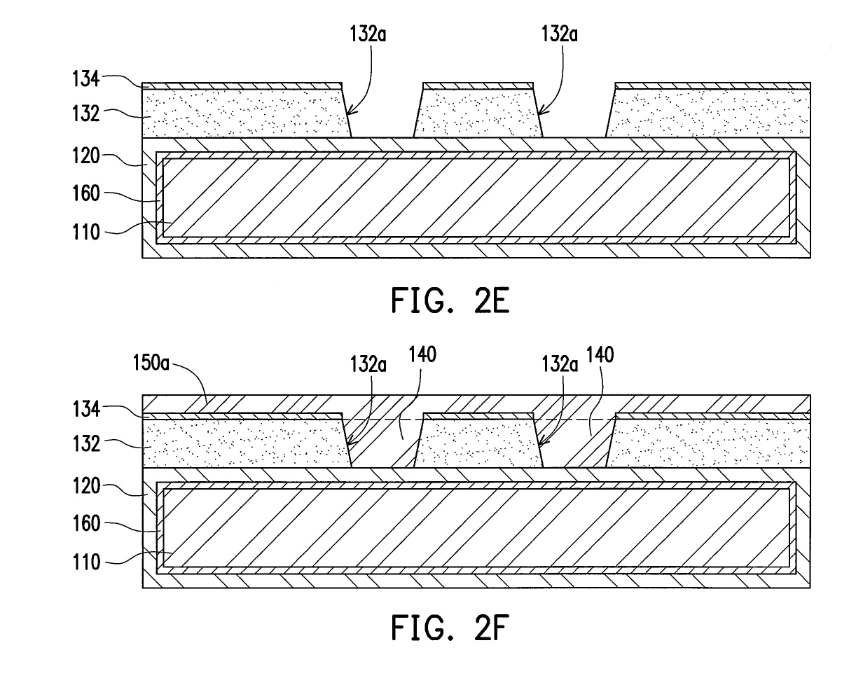

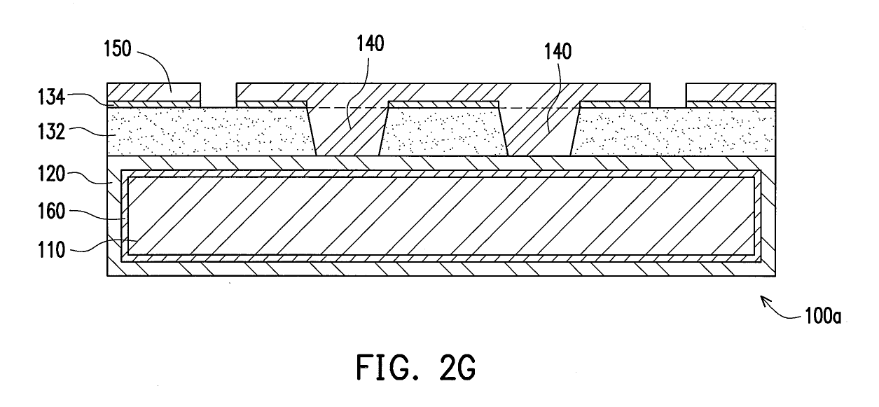

According to the above descriptions, only a structure of the thermal conductivity substrate 100 of the invention is introduced, and a manufacturing method thereof is not mentioned. Therefore, another embodiment is provided below to describe the manufacturing method of the thermal conductivity substrate 100 with reference of FIGS. 2A-2G.

FIGS. 2A-2G are cross-sectional views of a manufacturing method of a thermal conductivity substrate according to an embodiment of the invention. Referring to FIG. 2A, according to the manufacturing method of the thermal conductivity substrate 100, the metal substrate 110 is first provided. In the present embodiment, the metal substrate 110 is, for example, a copper substrate, a copper alloy substrate, an aluminium substrate or an aluminium alloy substrate with a good thermal conductivity, though the invention is not limited thereto. Here, the aluminium substrate is used as an example.

Then, referring to FIG. 2B, to facilitate a follow-up process of forming the metal layer 120, a surface treatment can be first performed to the metal substrate 110. Herein, the surface treatment is, for example, to form a medium layer 160 on the metal substrate 110 through a physical or a chemical process, wherein a material of the medium layer 160 is, for example, zinc or copper. Certainly, in other embodiments, the step of forming the medium layer 160 can also be omitted. In other words, the medium layer 160 can be selectively formed according to an actual requirement.

Then, referring to FIG. 2C, an electroplating process is performed to form the metal layer 120 on the metal substrate 110, wherein the metal layer 120 entirely covers the metal substrate 110. In the present embodiment, the medium layer 160 can be used as an electroplating seed layer to electroplate the metal layer 120 on the metal substrate 110. Moreover, a material of the metal layer 120 is, for example, copper.

Then, referring to FIG. 2D, a laminated structure 130 is compressed on the metal layer 120 through a thermal compression process, wherein the laminated structure 130 includes the insulating layer 132 and the first conductive layer 134.

Then, referring to FIG. 2E, the first conductive layer 134 is patterned according to an etching process, and a plurality of openings 132a exposing a portion of the metal layer 120 is formed in the insulating layer 132 according to a laser drilling process, wherein the openings 132a are, for example, trenches or holes.

Then, referring to FIG. 2F, a second conductive material layer 150a is formed on the first conductive layer 134 and inner walls of the openings 132a through an electroplating process, wherein the second conductive material layer 150a fills the openings 132a to form a plurality of the conductive structures 140, and the second conductive material layer 150a located on the first conductive layer 134 is connected to a portion of the metal layer 120 through the conductive structures 140.

Finally, the second conductive material layer 150a is patterned to form the second conductive layer 150 on the first conductive layer 134, wherein a method of patterning the second conductive material layer 150a is, for example, a photolithography process. Now, the second conductive layer 150 and the first conductive layer 134 there below may expose a portion of the insulating layer 132. By now, manufacturing of a thermal conductivity substrate 100a is completed.

In follow-up manufacturing processes, when a heat-generating element (for example, a light-emitting diode chip, which is not shown) is electrically connected to the second conductive layer 150 of the thermal conductivity substrate 100a through a wire bonding process or a flip chip bonding process, heat generated by the heat-generating element can be effectively conducted to external through the second conductive layer 150, the conductive structures 140, the metal layer 120 and the metal substrate 110. In brief, the thermal conductivity substrate 100a of the present embodiment can effectively dissipate the heat generated by the heat-generating element, so as to improve a utilization efficiency and utilization lifespan of the heat-generating element.

Since the aluminium substrate is used as the metal substrate 110, a whole weight of the thermal conductivity substrate 100a can be lighter compared to that of a copper substrate having the same size, which may facilitate moving operations and processing operations during the manufacturing process, so as to increase productivity and a process yield. Moreover, since a cost of the aluminium substrate is relatively low compared to that of the copper substrate having the same size, a production cost can be reduced. In addition, since the metal layer 120 (a material thereof is, for example, copper) entirely covers the metal substrate 110 (the aluminium substrate), during the etching process, the metal substrate 110 is protected from being etched by etchant, so that integrity and structure reliability of the metal substrate 110 are ensured.

In summary, in the thermal conductivity substrate of the invention, the metal layer entirely covers the metal substrate, and the conductive layer is connected to the metal layer through the conductive structures. Therefore, when a heat-generating element is disposed on the thermal conductivity substrate, heat generated by the heat-generating element can be quickly conducted to external through the conductive layer, the conductive structures, the metal layer and the metal substrate. In this way, the thermal conductivity substrate of the invention can effectively dissipate the heat generated by the heat-generating element, so as to improve a utilization efficiency and a utilization lifespan of the heat-generating element.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. A thermal conductivity substrate, comprising:
a metal substrate;
a metal layer, disposed on the metal substrate, and entirely covering the metal substrate;
an insulating layer, disposed on the metal layer;
a plurality of conductive structures, embedded in the insulating layer, and connected to a portion of the metal layer;
a first conductive layer, disposed on the insulating layer; and
a second conductive layer, disposed on the first conductive layer and the conductive structures, wherein the second conductive layer is connected to a portion of the metal layer through the conductive structures, and the second conductive layer and the conductive structures are integrally formed.

2. The thermal conductivity substrate as claimed in claim 1, further comprising a medium layer disposed between the metal substrate and the metal layer.

3. The thermal conductivity substrate as claimed in claim 2, wherein a material of the medium layer comprises zinc or copper.

4. The thermal conductivity substrate as claimed in claim 1, wherein the first conductive layer exposes a portion of the insulating layer.

5. A method for manufacturing a thermal conductivity substrate, comprising:
providing a metal substrate;
forming a metal layer on the metal substrate, wherein the metal layer entirely covers the metal substrate;
compressing a laminated structure on the metal layer, and the laminated structure comprising an insulating layer and a first conductive layer, wherein the insulating layer has a plurality of openings, and the openings expose a portion of the metal layer; and
forming a second conductive material layer on the first conductive layer and inner walls of the openings, wherein the second conductive material layer fills the openings to form a plurality of conductive structures, and the second conductive material layer located on the first conductive layer is connected to a portion of the metal layer through the conductive structures.

6. The method for manufacturing the thermal conductivity substrate as claimed in claim 5, further comprising:
performing a surface treatment to the metal substrate before forming the metal layer on the metal substrate.

7. The method for manufacturing the thermal conductivity substrate as claimed in claim 6, wherein the step of performing the surface treatment comprises:
forming a medium layer on the metal substrate.

8. The method for manufacturing the thermal conductivity substrate as claimed in claim 7, wherein a material of the medium layer comprises zinc or copper.

9. The method for manufacturing the thermal conductivity substrate as claimed in claim 7, wherein a method of forming the second conductive material layer on the first conductive layer and the inner walls of the openings comprises electroplating.

10. The method for manufacturing the thermal conductivity substrate as claimed in claim 5, further comprising:
patterning the second conductive material layer to form a second conductive layer on the first conductive layer after forming the second conductive material layer.
